(19) United States
(12) Patent Application Publication
(10) Pub. No.: US 2019/0200419 A1
(43) Pub. Date: Jun. 27, 2019

(54) ELECTROMAGNETIC COOKING APPLIANCE AND METHOD FOR CONTROLLING POWER OF THE SAME

(71) Applicant: FOSHAN SHUNDE MIDEA ELECTRICAL HEATING APPLIANCES MANUFACTURING CO., LTD., Foshan (CN)

(72) Inventors: Jun Lei, Foshan (CN); Jaeeun Byun, Foshan (CN); Yunfeng Wang, Foshan (CN); Lutian Zeng, Foshan (CN); Deyong Jiang, Foshan (CN); Fan Zhang, Foshan (CN); Shufeng Huang, Foshan (CN); Wenhua Liu, Foshan (CN); Yuehong Qu, Foshan (CN)

(21) Appl. No.: 16/288,116

(22) Filed: Feb. 28, 2019

Related U.S. Application Data
(63) Continuation of application No. PCT/CN2018/077600, filed on Feb. 28, 2018.

(30) Foreign Application Priority Data
Dec. 21, 2017 (CN) 201711390613.0

(51) Int. Cl. H05B 6/06; H05B 6/12; H02J 50/12

(52) U.S. Cl. CPC H05B 6/062; H02J 50/12; H05B 6/1245

(57) ABSTRACT

The present disclosure provides a method for controlling a power of an electromagnetic cooking appliance and an electromagnetic cooking appliance. The method for controlling the power includes the following steps: obtaining a target power of the electromagnetic cooking appliance; determining a heating period of the electromagnetic cooking appliance based on the target power, in which, each heating period includes at least one heating time period; in each heating time period, controlling a power switch corresponding to the first coil disk with a first control pulse, and controlling a power switch corresponding to the second coil disk with a second control pulse, to make the first coil disk and the second coil disk heat simultaneously with different powers, in which, when the first coil disk and the second coil disk heat simultaneously.

### CROSS-REFERENCE TO RELATED APPLICATIONS

This application is a continuation of International Application PCT/CN2018/077600, filed on Feb. 28, 2018, which claims priority to and the benefit of Chinese Patent Application No. 201711390613.0 filed with the Chinese Patent Office on Dec. 21, 2017, the entire contents of which are incorporated herein by reference.

### FIELD

The present disclosure relates to a field of household appliances, and more particularly to a method for controlling a power of an electromagnetic cooking appliance, and an electromagnetic cooking appliance.

### BACKGROUND

When a plurality of coil disks heat a cooking appliance simultaneously, since coupling interference of magnetic fields generated among coil disks, coil disks cannot simultaneously heat with different powers.

### SUMMARY

Embodiments of the disclosure is to provide a method for controlling a power of an electromagnetic cooking appliance, which may enable a plurality of coil disks to simultaneously heat with different powers.

A second objective of the present disclosure is to provide a non-transitory computer readable storage medium.

A third objective of the present disclosure is to provide an electromagnetic cooking appliance.

Embodiments of the present disclosure provides a method for controlling a power of an electromagnetic cooking appliance. The electromagnetic cooking appliance includes a first coil disk and a second coil disk. Each of the first coil disk and the second coil disk corresponds to an independent resonance circuit. The method for controlling the power includes the following steps: obtaining a target power of the electromagnetic cooking appliance; determining a heating period of the electromagnetic cooking appliance based on the target power, in which, each heating period includes at least one heating time period; in each heating time period, controlling a power switch corresponding to the first coil disk with a first control pulse, and controlling a power switch corresponding to the second coil disk with a second control pulse, to make the first coil disk and the second coil disk heat simultaneously with different powers, in which, when the first coil disk and the second coil disk heat simultaneously, an opening start time of the power switch corresponding to the first coil disk is the same with that of the power switch corresponding to the second coil disk in each switching period.

With the method for controlling the power of the electromagnetic cooking appliance according to one or more embodiments of the present disclosure, the target power of the electromagnetic cooking appliance is obtained; the heating period of the electromagnetic cooking appliance is determined based on the target power, in which each heating period includes at least one heating time period, and in each heating time period, the power switch corresponding to the first coil disk is controlled with the first control pulse, and the power switch corresponding to the second coil disk is controlled with the second control pulse, to make the first coil disk and the second coil disk heat simultaneously with different powers, in which, when the first coil disk and the second coil disk heat simultaneously, thereby enabling coil disks to simultaneously heat with different powers.

Additionally, the method for controlling the power of the electromagnetic cooking appliance provided in the above embodiments of the present disclosure may have the following additional technical features.

According to an embodiment of the present disclosure, each heating time period corresponds to a half-wave period of an input alternating current (AC) power supply.

According to an embodiment of the present disclosure, each heating period includes one heating time period, and the first coil disk and the second coil disk heat continuously and simultaneously.

According to an embodiment of the present disclosure, each heating period includes four heating time periods, in which, in a first heating time period and a second heating time period, the first coil disk and the second coil disk heat simultaneously; in a third heating time period and a fourth heating time period, the first coil disk heats, the second coil disk stops heating.

According to an embodiment of the present disclosure, each heating period includes four heating time periods, in which, in a first heating time period and a second heating time period, the first coil disk and the second coil disk heat simultaneously; in a third heating time period, the first coil disk heat, and the second coil disk stops heating; in a fourth heating time period, the first coil disk and the second coil disk stop heating simultaneously.

According to an embodiment of the present disclosure, when the first coil disk and the second coil disk heat simultaneously, a switch-on period of the power switch corresponding to the first coil disk is different from that of the power switch corresponding to the second coil disk in each switching period, and the switch period of the power switch corresponding to the first coil disk is the same with that of the power switch corresponding to the second coil disk.

According to an embodiment of the present disclosure, the heating period is less or equal to 320 ms.

According to an embodiment of the present disclosure, the first coil disk and the second coil disk are disposed concentrically or adjacently.

Embodiments of the present disclosure provides a non-transitory computer readable storage medium having stored computer programs thereon. The programs are performed by a processor to implement the method for controlling the power of the electromagnetic cooking appliance as described above.

With the non-transitory computer readable storage medium according to one or more embodiments of the present disclosure, by performing the method for controlling the power of the electromagnetic cooking appliance described above, it may enable coil disks to simultaneously heat with different powers.

Embodiments of the present disclosure provides an electromagnetic cooking appliance, including a first coil disk, a second coil disk, a memory, a processor and a power control program of the electromagnetic cooking appliance which is stored in the memory and executed by the processor. Each of the first coil disk and the second coil disk corresponds to an independent resonance circuit. The power control program of the electromagnetic cooking appliance is performed by the processor to realize the method for controlling the power of the electromagnetic cooking appliance as described above.

With the electromagnetic cooking appliance according to one or more embodiments of the present disclosure, by the method for controlling the power of the electromagnetic cooking appliance described above, it may enable coil disks to simultaneously heat with different powers.

### BRIEF DESCRIPTION OF THE DRAWINGS

FIG. 1 is a flow chart illustrating a method for controlling a power of an electromagnetic cooking appliance according to an embodiment of the present disclosure.

FIG. 2 is a schematic diagram illustrating a drive control circuit of an electromagnetic cooking appliance according to an embodiment of the present disclosure.

FIG. 3 is a schematic diagram illustrating a drive control circuit of an electromagnetic cooking appliance according to another embodiment of the present disclosure.

FIG. 4 is a waveform diagram illustrating a method for controlling a power of an electromagnetic cooking appliance according to an embodiment of the present disclosure.

FIG. 5 is a resonant waveform diagram illustrating a method for controlling a power of an electromagnetic cooking appliance according to an embodiment of the present disclosure.

FIG. 6 is a resonant waveform diagram illustrating a method for controlling a power of an electromagnetic cooking appliance according to another embodiment of the present disclosure.

FIG. 7 is a resonant waveform diagram illustrating a method for controlling a power of an electromagnetic cooking appliance according to another embodiment of the present disclosure.

### DETAILED DESCRIPTION

Reference will now be made in detail to embodiments of the present disclosure, examples of which are illustrated in the accompanying drawings, in which the same or similar numbers represent the same or similar elements or the elements with the same or similar function, the embodiments described in the following accompany drawings are exemplary, only for purpose of description of the present disclosure, but not constructed to limit the present disclosure.

A method for controlling a power of an electromagnetic cooking appliance and an electromagnetic cooking appliance provided in the embodiments of the present disclosure will be described below with reference to the accompanying drawings.

FIG. 1 is a flow chart illustrating a method for controlling a power of an electromagnetic cooking appliance according to an embodiment of the present disclosure.

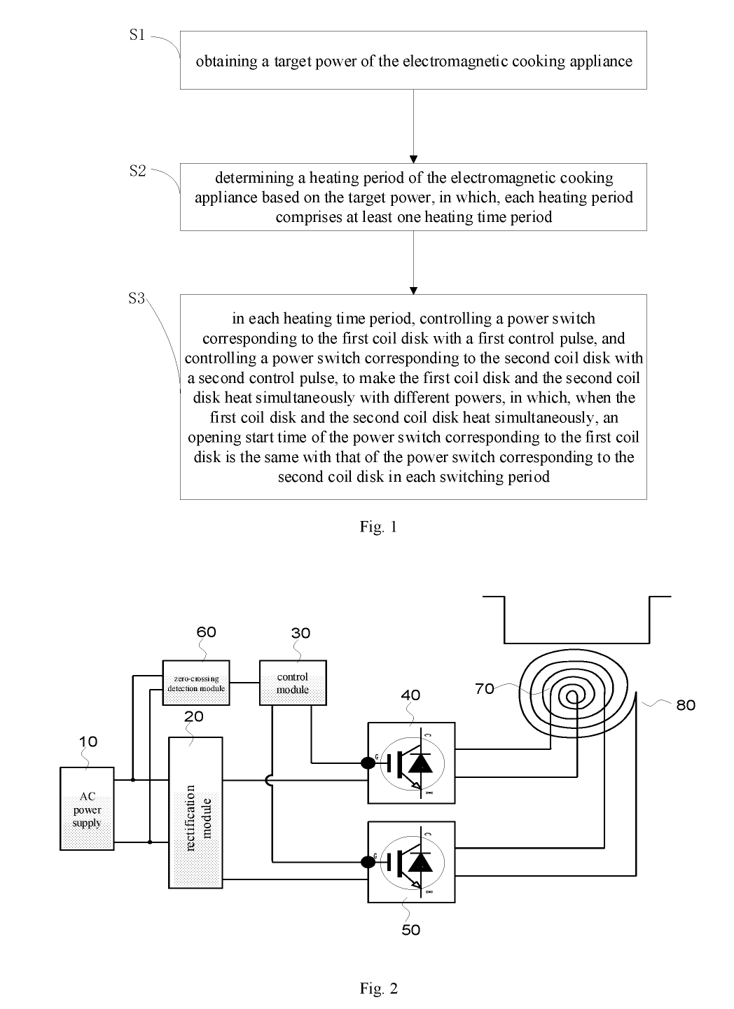

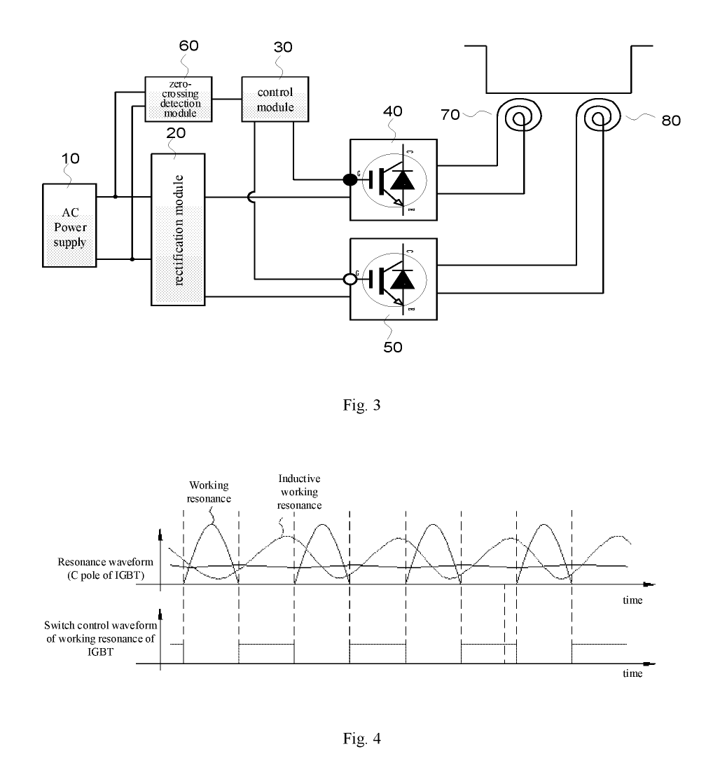

In one or more embodiments of the present disclosure, as illustrated in FIG. 2 and FIG. 3, the electromagnetic cooking appliance may include a first coil disk 70 and a second coil disk 80. Each of the first coil disk 70 and the second coil disk 80 corresponds to an independent resonance circuit. As illustrated in FIG. 2, the first coil disk 70 and the second coil disk 80 may be disposed concentrically. Or as illustrated in FIG. 3, the first coil disk 70 and the second coil disk 80 may be disposed adjacently.

In detail, as illustrated in FIG. 2 and FIG. 3, a drive control circuit of the electromagnetic cooking appliance may include an AC power supply 10, a rectification device 20, a control device 30, a first power switch 40, a second power switch 50 and a zero-crossing detection device 60. The first power switch 40 and the second power switch 50 may be an insulated gate bipolar translator (IGBT). Each of the first coil disk 70 and the second coil disk 80 has an independent resonance circuit. That is, the first power switch 40 is configured to control the first coil disk 70 to turn on or off, and the second power switch 50 is configured to control the second coil disk 80 to turn on or off. The zero-crossing detection device 60 is configured to detect a zero-crossing signal of the AC power supply. The rectification device 20 is configured to rectify the input AC power supply into a direct current (DC) power. The switch device is configured to invert the rectified DC signal into a high frequency signal above 20 KHz. The high frequency signal may be changed from an electrical signal into an alternating electromagnetic signal by the coil disk. The electromagnetic cooking appliance (a heated body) generates an eddy current and a hysteresis motion in the alternating electromagnetic signal, thereby generating energy.

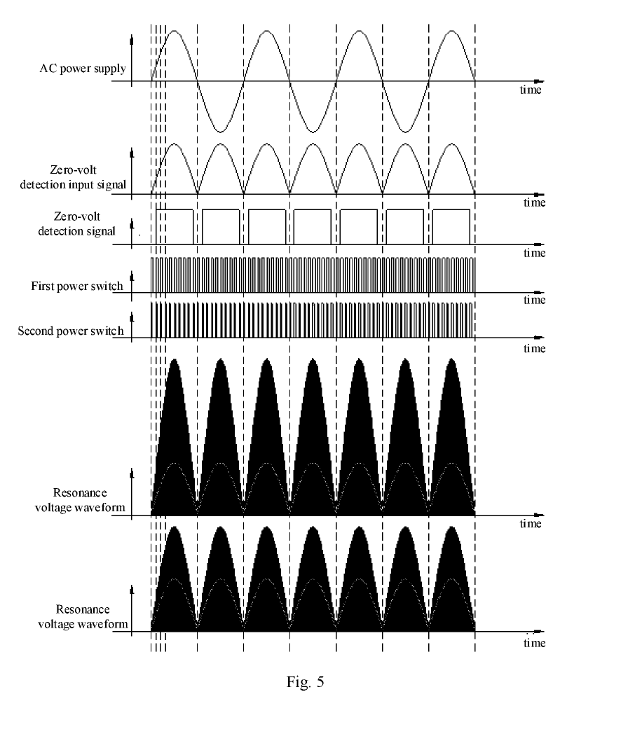

As illustrated in FIG. 4, when one of the power switches controls the corresponding coil disk to operate, an alternating magnetic field is generated around the coil disk and around the heated body, and the coil disk that is not controlled by the power switch will generate a follow-up resonance with the same frequency in the alternating magnetic field. An arrival times of the two resonances to reach a valley are very close.

As illustrated in FIG. 1, the method for controlling the power of the electromagnetic cooking appliance according to one or more embodiments of the present disclosure may include the following steps.

S1, a target power of the electromagnetic cooking appliance is obtained.

S2, a heating period of the electromagnetic cooking appliance is determined based on the target power. Each heating period includes at least one heating time period. In one or more embodiments of the present disclosure, each heating time period corresponds to one half-wave period of the input AC power supply. The heating period is less or equal to 320 ms. It should be noted that 320 ms is 32 half-wave periods of the AC power supply, the minimum heating period is to heat a half-wave period of the AC power supply for l0 ms and stop for 310 ms. A minimum average power is a reference power P*1/32. If the minimum reference control power is 3200 W, the minimum power is 100 W, and the smaller the heating period, the more uniform heating, by combining with the minimum control power and heating uniformity, the heating period is limited to within 320 ms.

S3, in each heating time period, a power switch corresponding to the first coil disk is controlled with a first control pulse, and a power switch corresponding to the second coil disk is controlled with a second control pulse, to make the first coil disk and the second coil disk heat simultaneously with different powers. When the first coil disk and the second coil disk heat simultaneously, an opening start time of the power switch corresponding to the first coil disk is the same with that of the power switch corresponding to the second coil disk in each switching period.

In detail, the target power of the electromagnetic cooking appliance is obtained after the electromagnetic cooking appliance is powered on, and then the heating period of the electromagnetic cooking appliance is determined based on the target power. Each heating period may include at least one heating time period. In each heating time period, the power switch corresponding to the first coil disk and the power switch corresponding to the second coil disk are controlled with different control pulses, and the two power switches are controlled to be the same at the beginning of the opening in each switching period. Therefore, a purpose of heating by the first coil disk and the second coil disk at the same time and with different powers is realized, and the heating is stopped until a present heating power of the cooking appliance reaches a preset target power. For example, when the first coil disk and the second coil disk simultaneously heat, a coil disk (assuming the first coil disk) with a heating maximum power is made as the reference, the power switches may be turned on at the same time, to realize the first coil disk and the second coil disk to heat simultaneously, and the power switches may be turned off at the same time or different time (i.e., widths of the control pulses are the same or different; the same power heating is realized when the widths of the control pulses are the same; and different power heating is realized when the widths of the control pulses are different), such as, the power switch corresponding to the first coil disk is controlled with the first control pulse, and the power switch corresponding to the second coil disk is controlled with the second control pulse, the pulse width of the first control pulse may be greater than the pulse width of the second control pulse, to make the first coil disk and the second coil disk heat with different powers.

The current heating power of the electromagnetic cooking appliance is a sum of a heating power of the first coil disk for each first heating period and a heating power of the second coil disk for each second heating period.

When the first coil disk and the second coil disk heat simultaneously, a switch-on period of the power switch corresponding to the first coil disk is different from that of the power switch corresponding to the second coil disk in each switching period, and the switch period of the power switch corresponding to the first coil disk is the same with that of the power switch corresponding to the second coil disk, according to an embodiment of the present disclosure.

Namely, in each switch period, if the first coil disk is turned on at T1, and turned off at T2, and if the second coil disk is turned on at t1, and turned off at t2, T1>t1, and T1+T2=t1+t2. Thus, the first coil disk and the second coil disk may be sure to heat simultaneously.

The heating period including the heating time period will be described below.

According to an embodiment of the present disclosure, each heating period includes one heating time period, and the first coil disk and the second coil desk heat continuously and simultaneously.

Namely, as illustrated in FIG. 5, in the heating time period, the first power switch the first is controlled with the first control pulse, and the second power switch is controlled with the second control pulse, and the width of the first control pulse is different from the width of the second control pulse, and the first power switch and the second power switch are turned on at the same time, to realize the first coil disk and the second coil disk to heat simultaneously and continuously with different powers, until the current heating power of the cooking appliance reaches the preset target power. Thus, the first coil disk and the second coil disk are controlled to heat simultaneously, each heating period is a half period of the AC power supply, and the output power is the same in each period. There is no power flicker and interference to the power grid is small.

According to another embodiment of the present disclosure, each heating period includes four heating time periods. In a first heating time period and a second heating time period, the first coil disk and the second coil disk heat simultaneously; in a third heating time period and a fourth heating time period, the first coil disk heats, and the second coil disk stops heating.

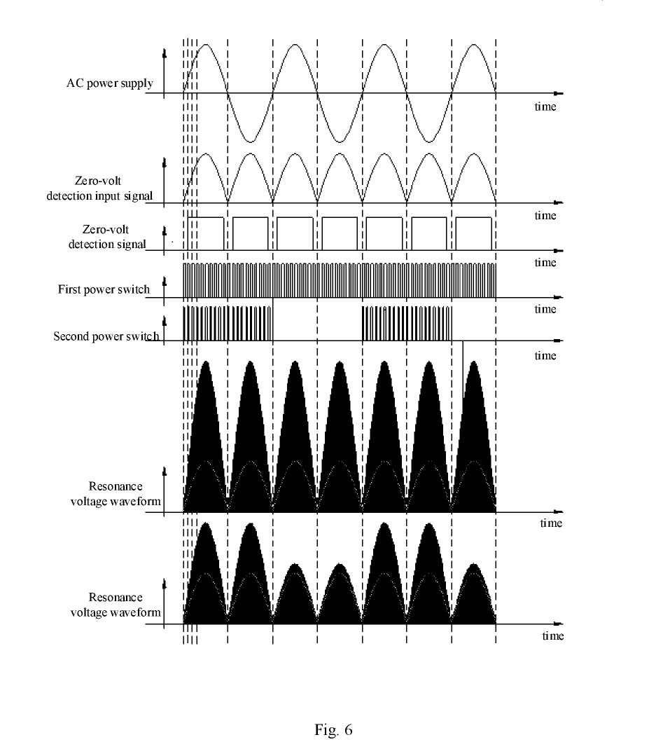

Namely, as illustrated in FIG. 6, in the first heating time period and the second heating time period, the first power switch is controlled with the first control pulse, and the second power switch is controlled with the second control pulse, and the width of the first control pulse is different from the width of the second control pulse, and the first power switch and the second power switch are turned on at the same time, to realize the first coil disk and the second coil disk to heat simultaneously and continuously with different powers. In the third heating time period and the fourth heating time period, the first power switch is still controlled with the first control pulse, and the second power switch is controlled to be turned off, to make the first coil disk heat, and the second coil disk stop heating. During the time, the present power of the electromagnetic cooking appliance may be adjusted. Thus, by controlling the output power of the first coil disk to be less than the minimum continuous output power allowed by the system, the second coil disk adopts an intermittent heating control method to achieve the purpose of simultaneously heating and enhance the uniform heating effect.

According to another embodiment of the present disclosure, each heating period includes four heating time periods. In a first heating time period and a second heating time period, the first coil disk and the second coil disk heat simultaneously; in a third heating time period, the first coil disk heat, and the second coil disk stops heating; in a fourth heating time period, the first coil disk and the second coil disk stop heating simultaneously.

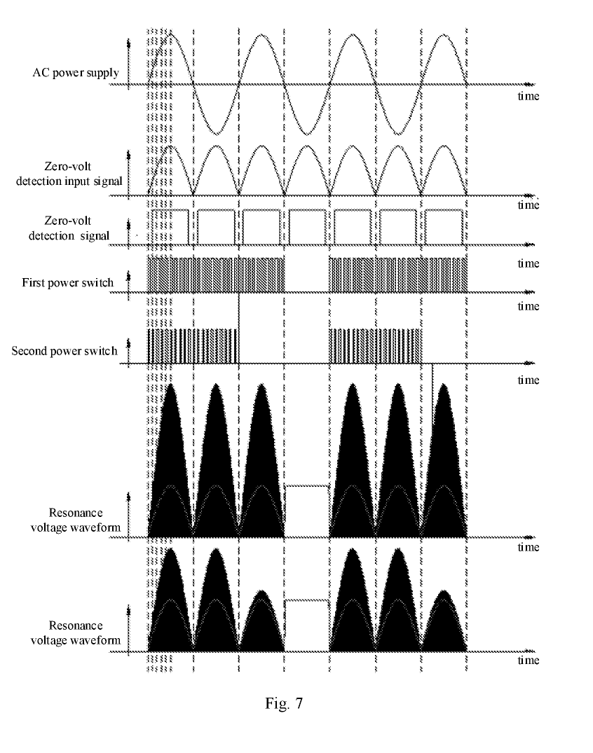

Namely, as illustrated in FIG. 7, in the first heating time period and the second heating time period, the first power switch is controlled with the first control pulse, and the second power switch is controlled with the second control pulse, and the width of the first control pulse is different from the width of the second control pulse, and the first power switch and the second power switch are turned on at the same time, to realize the first coil disk and the second coil disk to heat simultaneously with different powers. In the third heating time period, the first power switch is still controlled with the first control pulse, and the second power switch is controlled to be turned off, to make the first coil disk heat, and the second coil disk stop heating. In the fourth heating time period, the first power switch and the second power switch are controlled to be turned off. During the time, the present power of the electromagnetic cooking appliance may be adjusted. Thus, by controlling the output powers of the two coil disks to be less than the minimum continuous output power allowed by the system, the two coil disks adopt an intermittent heating control method to achieve the purpose of simultaneously heating and enhance the uniform heating effect.

From the above, as illustrated in FIG. 5-FIG. 9, since the alternating magnetic field is generated around the first coil disk when the first coil disk is controlled to heat, a resonance voltage is generated in a corresponding resonance circuit of the first coil disk, and a resonance voltage (less than the resonance voltage generated by the corresponding resonant circuit of the first coil disk) is generated in a corresponding resonance circuit of the second coil disk even if the second coil disk does not heat. Likewise, when the second coil disk is controlled to heat, even if the first coil disk does not heat, the resonance circuit corresponding to the first coil disk also generates a resonance voltage.

In conclusion, with the method for controlling the power of the electromagnetic cooking appliance according to one or more embodiments of the present disclosure, the target power of the electromagnetic cooking appliance is obtained; the heating period of the electromagnetic cooking appliance is determined based on the target power, in which each heating period includes at least one heating time period, and in each heating time period, the power switch corresponding to the first coil disk is controlled with the first control pulse, and the power switch corresponding to the second coil disk is controlled with the second control pulse, to make the first coil disk and the second coil disk heat simultaneously with different powers, in which, when the first coil disk and the second coil disk heat simultaneously, thereby enabling coil disks to simultaneously heat with different powers.

Further, one or more embodiments of the present disclosure provide a non-transitory computer readable storage medium having stored computer programs thereon. The method for controlling the power of the electromagnetic cooking appliance described above may be implemented when the programs are performed by a processor.

With the non-transitory computer readable storage medium according to one or more embodiments of the present disclosure, by performing the method for controlling the power of the electromagnetic cooking appliance described above, it may enable coil disks to simultaneously heat with different powers.

Further, one or more embodiments of the present disclosure provide an electromagnetic cooking appliance, including a first coil disk, a second coil disk, a memory, a processor and programs stored in the memory and executed by the processor for controlling a power of an electromagnetic cooking appliance. Each of the first coil disk and the second coil disk corresponds to an independent resonance circuit. The method for controlling the power of the electromagnetic cooking appliance described above may be implemented when the programs of controlling a power of the electromagnetic cooking appliance is performed.

It should be noted that for details of the electromagnetic cooking appliance according to the embodiments of the present disclosure not described herein, reference may be made to the details disclosed in the method for controlling the power of the electromagnetic cooking appliance according to the embodiments of the present disclosure, which are not repeated here.

With the electromagnetic cooking appliance according to one or more embodiments of the present disclosure, by the method for controlling the power of the electromagnetic cooking appliance described above, it may enable coil disks to simultaneously heat with different powers.

In the description of the present disclosure, it is to be understood that, terms such as “center”, “longitudinal”, “lateral”, “length”, “width”, “thickness”, “over”, “below”, “front”, “back”, “left”, “right”, “vertical”, “horizontal”, “top”, “bottom”, “in”, “out”, “clockwise”, “anti-clockwise”, “axial”, “radial” and “circumference” refer to the directions and location relations which are the directions and location relations shown in the drawings, and for describing the present disclosure and for describing in simple, and which are not intended to indicate or imply that the device or the elements are disposed to locate at the specific directions or are structured and performed in the specific directions, which could not to be understood to the limitation of the present disclosure.

In addition, terms such as “first” and “second” are used herein for purposes of description and are not intended to indicate or imply relative importance or significance. Furthermore, the feature defined with “first” and “second” may comprise one or more this feature distinctly or implicitly. In the description of the present disclosure, “a plurality of” means two or more than two, unless specified otherwise.

In the present disclosure, unless specified or limited otherwise, the terms “mounted,” “connected,” “coupled” and “fixed” are understood broadly, such as fixed, detachable mountings, connections and couplings or integrated, and can be mechanical or electrical mountings, connections and couplings, and also can be direct and via media indirect mountings, connections, and couplings, and further can be inner mountings, connections and couplings of two components or interaction relations between two components.

In the present disclosure, unless specified or limited otherwise, the first characteristic is “on” or “under” the second characteristic refers to the first characteristic and the second characteristic can be direct or via media indirect mountings, connections, and couplings. And, the first characteristic is “on”, “above”, “over” the second characteristic may refer to the first characteristic is right over the second characteristic or is diagonal above the second characteristic, or just refer to the horizontal height of the first characteristic is higher than the horizontal height of the second characteristic. The first characteristic is “below” or “under” the second characteristic may refer to the first characteristic is right over the second characteristic or is diagonal under the second characteristic, or just refer to the horizontal height of the first characteristic is lower than the horizontal height of the second characteristic.

In the description of the present disclosure, reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. Thus, the appearances of the phrases in various places throughout this specification are not necessarily referring to the same embodiment or example of the present disclosure. Furthermore, the particular features, structures, materials, or characteristics may be combined in any suitable manner in one or more embodiments or examples.

What is claimed is:

1. A method for controlling a power of an electromagnetic cooking appliance, wherein, the electromagnetic cooking appliance comprises a first coil disk and a second coil disk, each of the first coil disk and the second coil disk corresponds to an independent resonance circuit, and the method for controlling the power comprises:
obtaining a target power of the electromagnetic cooking appliance;
determining a heating period of the electromagnetic cooking appliance based on the target power, wherein, each heating period comprises at least one heating time period;
in each heating time period, controlling a power switch corresponding to the first coil disk with a first control pulse, and controlling a power switch corresponding to the second coil disk with a second control pulse, to make the first coil disk and the second coil disk heat simultaneously with different powers, wherein, when the first coil disk and the second coil disk heat simultaneously, an opening start time of the power switch corresponding to the first coil disk is the same with that of the power switch corresponding to the second coil disk in each switching period.

2. The method according to claim 1, wherein each heating period corresponds to a half-wave period of an input alternating current (AC) power supply.

3. The method according to claim 1, wherein each heating period comprises one heating time period, and the first coil disk and the second coil desk heat continuously and simultaneously.

4. The method according to claim 1, wherein each heating period comprises four heating time periods, in which,
in a first heating time period and a second heating time period, the first coil disk and the second coil disk heat simultaneously;
in a third heating time period and a fourth heating time period, the first coil disk heat, and the second coil disk stops heating.

5. The method according to claim 1, wherein each heating period comprises four heating time periods, in which,
in a first heating time period and a second heating time period, the first coil disk and the second coil disk heat simultaneously;
in a third heating time period, the first coil disk heat, and the second coil disk stops heating;
in a fourth heating time period, the first coil disk and the second coil disk stop heating simultaneously.

6. The method according to claim 1, wherein when the first coil disk and the second coil disk heat simultaneously, a switch-on period of the power switch corresponding to the first coil disk is different from that of the power switch corresponding to the second coil disk in each switching period, and the switch period of the power switch corresponding to the first coil disk is the same with that of the power switch corresponding to the second coil disk.

7. The method according to claim 1, wherein the heating period is less or equal to 320 ms.

8. The power control method of the electromagnetic cooking appliance according to claim 1, the first coil disk and the second coil disk are disposed concentrically or adjacently.

9. A non-transitory computer readable storage medium having stored computer programs thereon, wherein the program is performed by the processor to realize a power control method the electromagnetic cooking appliance according to claim 1.

10. An electromagnetic cooking appliance, comprising:
a first coil disk, a second coil disk, a memory, a processor and a power control program of the electromagnetic cooking appliance which is stored in the memory and can operate on the processor, wherein, the first coil disk and the second coil disk correspond to independent resonance circuit respectively, the power control program of the electromagnetic cooking appliance is performed by the processor to realize the power control method of the electromagnetic cooking appliance according to claim 1.
